(19) United States
(12) Patent Application Publication
(10) Pub. No.: US 2007/0056937 A1
(43) Pub. Date: Mar. 15, 2007

(54) Modular units

(75) Inventors: Colin Jones, Cambridge (GB); Stephen Gage, Cambridge (GB); Kunal Patel, Cambridge (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Genome Research Ltd., Cambridge (GB)

(21) Appl. No.: 10/582,507

(22) PCT Filed: Dec. 10, 2004
(86) PCT No.: PCT/GB04/05159

§ 371 Date: Jun. 9, 2006

(30) Foreign Application Priority Data
Dec. 10, 2003 (GB) 0328672.1

(51) Int. Cl. B23K 9/00; B23K 9/02

(52) U.S. Cl. 219/121.5

(57) ABSTRACT

A modular unit (1) for transporting work pieces (40) and suitable for use in an array of such units, comprises a top (5); transportation means (10) which propel the work pieces onto and/or off said top (10) and against which the work pieces rest when located on the top (5) of the unit, the transportation means (10) being part of said top (5); in which the transportation means occupy one or more regions of the top (5) of the unit (1) whilst one or more remaining regions of the top are not occupied by transportation means (10) but are suitable for receiving a work piece treatment device.

### FIELD OF THE INVENTION

The invention relates to modular units for transporting work pieces and suitable for use in an array of such units. The invention also relates to arrays of modular units for transporting work pieces.

The invention will have particular applications in the following fields:
Genetics;
Manufacture, for example printed circuit boards (PCB) or similar electronic components;
Package sorting/handling;
Other appropriate automated processing systems.

### BACKGROUND TO THE INVENTION AND PRIOR ART KNOWN TO THE APPLICANTS

Broadly, known transportation systems are either conveyor-based systems or gripper-based systems. Work pieces transported for processing in traditional systems are usually placed beneath or on top of processing devices. For top side processing such as liquid handling, a conventional conveyor system may be employed whilst for thermocycling for example a gripper-based system may be employed to place the work piece either on top or within a thermo-cycling device.

In traditional conveyor-based systems, it is not possible to treat a work piece from below or simultaneously from above and below a work piece without removing the work piece from the transportation system. Typically, a gripper-based mechanism must be used to first remove the plate from the conveyor and then place it on to a dedicated processing station.

Another drawback of traditional systems is that, when these are used to carry out a frequently changing variety of actions, these often require the substitution of the entire system and the design of a new non-adaptable system as its temporary replacement. This comes at a very high cost indeed which often results in the traditional systems being used in combination with other systems which causes excessive space to be used in order to meet the requirements of the moment. This problem is accentuated particularly in genetic analysis where the range of operations and their sequence largely varies whilst the quantity of operations to be performed is astronomical.

One of the advantages sought to be achieved by the present invention is to provide a modular unit which facilitates the transportation of work pieces whilst allowing their treatment, either from below, simultaneously from above and below or even from above only, without having to remove them from the modular unit.

Another advantage sought is to improve the way in which to transport work pieces in an X and Y plane.

A further advantage sought is to provide a modular unit which allows the removal of work pieces from the top of the unit to allow the continuation of the transport of work pieces whilst a work piece is lifted.

A further advantage sought is to provide an array of modular units under improved control systems to allow a more efficient multi-discipline processing of units.

The following patent applications constitute the prior art known to the applicants:
U.S. Pat. No. 6,068,393 (Zymark);
U.S. Pat. No. 6,374,989 (Bayer);
US2002/0102149 (Tek Cel);
WO02/49761/A2 (Protedyne);
U.S. Pat. No. 4,850,472 (GMN)

The present invention distinguishes itself, from the general background of the art discussed above and the specific patent references, by the features detailed in the following section.

### SUMMARY OF THE INVENTION

In its first broad aspect, the invention provides a modular unit for transporting work pieces and suitable for use in an array of such units, comprising a top; transportation means which propel the work pieces onto and/or off said top and against which the work pieces rest when located on the top of the unit, the transportation means being part of said top; in which the transportation means occupy one or more regions of the top of the unit whilst one or more remaining regions of the top are not occupied by transportation means but are suitable for receiving a work piece treatment device.

This configuration of features is particularly advantageous because it allows treatment from below the work piece and from above and below alongside the transportation system. It is also particularly advantageous because it allows considerable savings of time and space in automating complex processes that typically include a succession of different processes to be applied to the work pieces. By minimising the requirement of removing the work pieces from the top, it allows for more efficient processing. It is also particularly beneficial in terms of its achievable compactness and flexibility.

In a subsidiary aspect in accordance with the invention's broadest aspect, the transportation means are located substantially about the periphery of the top and the region of the top of the unit located within the periphery of the top is suitable for receiving a work piece treatment device.

This configuration is particularly beneficial because it allows the stable propelling of work pieces whilst achieving improved work piece treatment. It will be particularly beneficial in terms of allowing the work piece to be treated from below without requiring the work piece gripped and lifted onto a specific work piece treatment device for treating from below the work piece.

In a further subsidiary aspect, the transportation means comprise a wheel, a drive causing the wheel to rotate and means to selectively engage the wheel with a work piece when a work piece is located on top of the unit.

This additional combination of features would allow the unit to be controlled in order to displace a work piece in a given direction or not to direct the work piece in that direction should the modular unit be controlled not to displace the work piece in that manner.

In a further subsidiary aspect, the unit comprises at least one wheel for driving the work piece in one direction and at least one second wheel which selectively engages the work piece and is oriented, in use, in a second direction.

One of the advantages of this configuration would be to allow the work piece to be readily displaced from one line of action to another without requiring the typical lifting and rotating of the work piece itself.

In a further subsidiary aspect, the unit's at least one second wheel not only engages the work piece but is adapted to lift the work piece so that the work piece only engages the second wheel.

This would allow the second wheel to exclusively control, in one mode of operation, the direction in which the work piece is to be displaced. In this configuration, the rotation of the first wheel set would cease to propel the work piece. This may allow the rotation of the first wheel set to freely continue during the actuation of the second wheel set.

In a further subsidiary aspect, the units at least one wheel and the unit's at least one second wheel are orthogonal one relative to the other. This is particularly advantageous because it allows the work piece's line of displacement to be readily changed without requiring the rotation of the work piece itself.

In a further subsidiary aspect, the unit comprises two compartments: one for receiving a work piece treatment device located in an upper compartment of the unit and a second containing the control electronics; and a separating member is provided to seal the second compartment from the first compartment.

This has particular benefits when the upper compartment for example is cleaned using a substance which would otherwise damage the control electronics.

In a further subsidiary aspect, work piece lifting means are provided to lift the work piece, the lifting means being sufficiently spaced to allow the transportation means to continue to transport work pieces whilst lifting one work piece.

In a further subsidiary aspect, the invention provides an array of modular units wherein the units are each in accordance with any of the preceding aspects and of substantially equal height and control means are provided to control the displacement in the X and Y plane from one unit to another.

When the modular units are placed in an array of modular units in this manner, the advantages as to flexibility and compactness of the system are emphasised.

In a further subsidiary aspect, each unit's control means allows the direct communication from one unit to its direct neighbouring units, whereby the transportation from one unit to the next may be co-ordinated.

In a further subsidiary aspect, a further array of modular units is suspended above the units comprising work piece treatment devices. This configuration would allow improved treatment of work pieces from both above and below the work pieces.

In a further subsidiary aspect, the control means stores a number of operative protocols depending on work piece types, selects the appropriate operative protocol dependent on the work piece to instruct the operation of a series of units, and scheduling means are provided, whereby several protocols may run in parallel in the array of modular units.

This configuration of features would allow optimal operation of a multi-task modular array of units.

In a further subsidiary aspect, one or more plates are provided with recessed portions into which modular units are selectively inserted and removed. This allows a grouping of modular units to be built up in an accurate manner.

In a further subsidiary aspect, the modular units comprise means which protrude from the top of the unit and which are so sized and shaped to engage a conical recessed portion of a work piece when located on the top whereby the position of the work piece on the top of the unit may be accurate.

In a further subsidiary aspect, the modular units operate in conjunction with a pallet which has one or more recessed tracks corresponding to one or more wheels, this feature also allows the position of the pallet to be highly accurate relative to the modular units and treatment devices.

In a further subsidiary aspect, the modular unit comprises a sensor for sensing the position of a work piece when located over said sensor. This allows highly accurate positioning of a work piece relative to the modular unit.

In a second broad aspect, the invention provides a tensioning arrangement, for a belt drive or chain drive of the kind in which a temporarily induced slackness in the belt or chain must be compensated automatically and followed, if subsequently necessary, by a correspondingly opposite sense movement of the tensioning means to release the tension previously imposed; characterised in that the tensioning means comprises first and second arms arranged in a mirror-image formation to bear simultaneously in use against respectively opposite runs of the belt or chain. This is particularly advantageous because when used in a modular unit it prevents the wheels to rotate in the opposite direction to their conventional direction of rotation when the set of wheels is displaced relative to their drive wheel.

### BRIEF DESCRIPTION OF THE FIGURES

FIG. 1 shows a perspective view of an X modular unit.

FIG. 2 shows a perspective inner-detailed view of an X modular unit.

FIG. 3 shows a perspective inner-detailed view of a Y modular unit.

FIG. 4 shows a perspective view of an XY modular unit.

FIG. 5 shows a perspective schematic view of a further embodiment of the invention.

FIG. 6 shows a perspective schematic view of a further embodiment of the invention.

FIG. 7 shows an array of lower modular units operating in conjunction with an array of upper modular units.

FIG. 8 shows a further array of lower modular units.

FIG. 9 shows a further embodiment of a modular unit in accordance with the present invention.

FIG. 10 shows a perspective view of a head operating in conjunction with a work piece.

FIG. 11 shows a perspective view of a pump unit.

FIG. 12 shows a head supporting frame in perspective view.

FIG. 13 shows a work piece and pallet assembly in perspective view.

FIG. 14 shows an array of modular units and their platform in perspective view.

FIG. 15 shows a perspective view of an outer enclosure suitable for use with an array of modular units of the invention.

FIG. 16 is a flow diagram of the air flow within an enclosure in a ‘cleaning’ mode.

FIG. 17 shows a flow diagram of the air flow within an enclosure in a ‘running’ mode.

FIG. 18 shows in plan view a tensioning mechanism suitable for tensioning the conveyor belt for the modular units of the prevent invention.

### DETAILED DESCRIPTION OF THE FIGURES

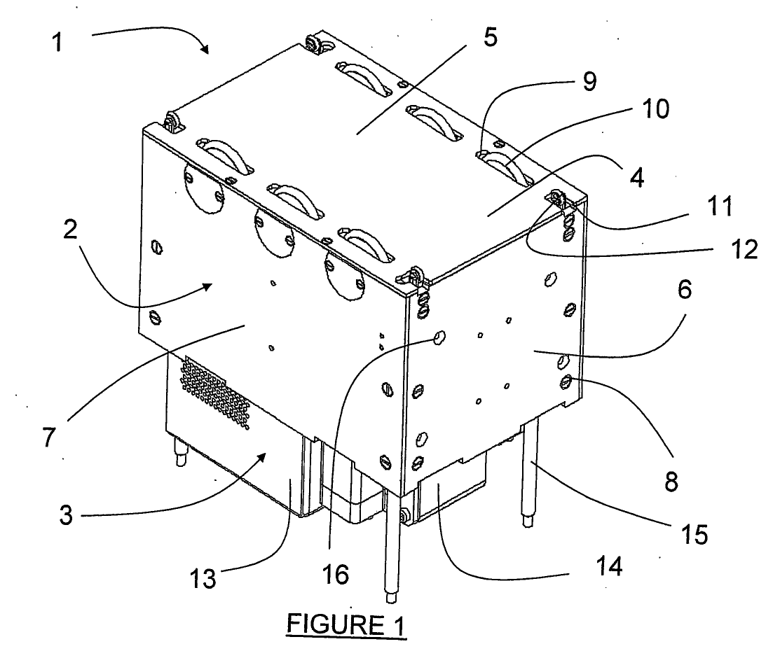

FIG. 1 shows a modular unit generally referenced 1 with an upper compartment referenced 2 and a lower compartment generally referenced 3. Upper compartment 2 comprises a housing 4 formed from a number of plates acting as walls for each side of the housing. Only plates 5, 6 and 7 can be seen in the perspective view of FIG. 1. An appropriate number of screws such as that referenced 8 are provided as part of the means to attach the various walls together in order to form housing 4. The top plate 5 of the housing incorporates a number of longitudinal cut-out regions such as that referenced 9 allowing a number of wheels such as that referenced 10 to protrude from the plate in order to be able to engage a work piece for propelling the work piece onto and/or off the top of this modular unit. Two sets of wheels are provided in this modular unit, each being oriented in the same direction and being spaced apart from one another and located generally on the periphery of the top plate 5. The space provided between the two sets of wheels may be suitable for incorporating a work piece treatment device. Further cut-outs such as that referenced 11 are provided in the top plate S, each of which accommodates an idle wheel such as that referenced 12 designed to prevent work pieces jamming between modular units if used in an array of such units. In addition to these wheels, vertically displaceable rods (not shown in the figure) may be provided in each corner or outer periphery regions of the modular unit. These may have rounded tips so as to allow mating engagement (when lifted through pneumatic means) with conical recesses located in the underneath of a work piece or pallet in order to allow the pallet to be accurately located over the modular unit.

Lower compartment 3 incorporates part of the control means of the modular unit. The control means may comprise electronic control means 13 and a motor 14 which may be selected by the person skilled in the art to control the periodic motion of the sets of wheels of the top plate of the modular unit. Legs such as that referenced 15 are provided whose length is selected to allow sufficient clearance between the lower compartment 3 of the unit and the ground. The legs may also be placed at a sufficient distance from the motor to allow air flow for cooling purposes. Other apertures in the plates such as that referenced 16 may be provided to allow the releasable attachment of say a drive mechanism or other work piece treatment device within the upper compartment of the unit.

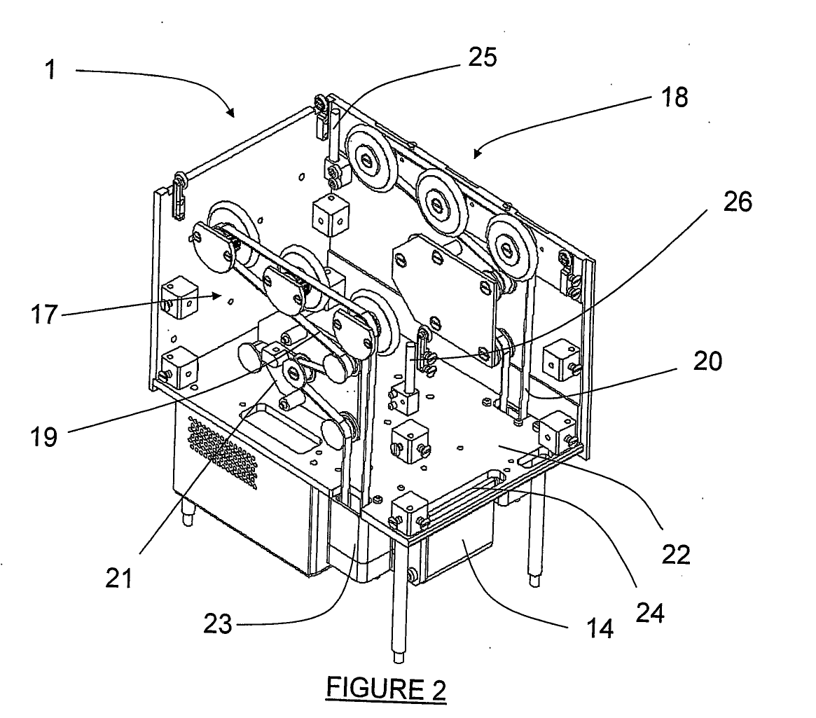

FIG. 2 shows an inside perspective view of modular unit 1. The two sets of wheels generally referenced 17 and 18 are illustrated alongside their respective drive belts 19 and 20 which drive the rotation of the wheel sets when actuated upon by the motor 14. A constant force spring 21 is also provided to maintain the drive belt in tension for correct transmission of rotation to the wheels. As can be seen, the wheel sets are so arranged at the periphery of the housing so that a relatively large empty space in a central region of the housing results which would be ideal to receive an appropriate work piece treatment device as selected by the person skilled in the art. This central region may also be occupied by a circuit board or a drive mechanism as appropriate.

A bottom plate 22 is provided and is part of the means to seal the lower compartment from the upper compartment of the unit. An enclosure 23 is also provided as part of the means to seal the lower compartment from the upper compartment but is adapted specifically to allow, whilst providing sufficient sealing, the passage of the belt or belts. Several cut-outs such as that referenced 24 may also be provided in bottom plate 22 to allow supply lines to pass if required. The supply lines may include electricity conducting means, fluid conduits and optical transmitters. A couple of sensors 25 and 26 located in opposite corners of the unit have been provided to detect the presence or absence of work pieces. These sensors may be optical sensors with a relatively short focal length and an operative wavelength selected so that the sensors are triggered only when a work piece is located above the sensors.

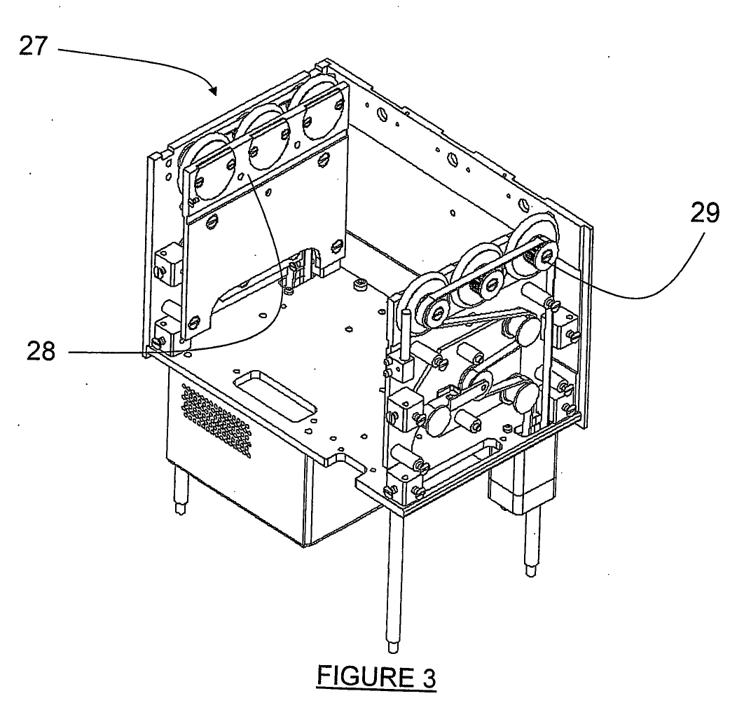

FIG. 3 shows a second unit type generally referenced 27. This unit's line of action is in the Y direction, the unit may therefore be referred to as a Y modular unit. The periphery of this unit is similar to the periphery of unit 1 described in either FIGS. 1 or 2. The main difference is that it comprises two sets of wheels referenced 28 and 29 which are located at the periphery of the unit but along the shorter sides of the unit so that work pieces may be propelled in the Y direction. The large empty space in this configuration can be clearly seen between set 28 and 29.

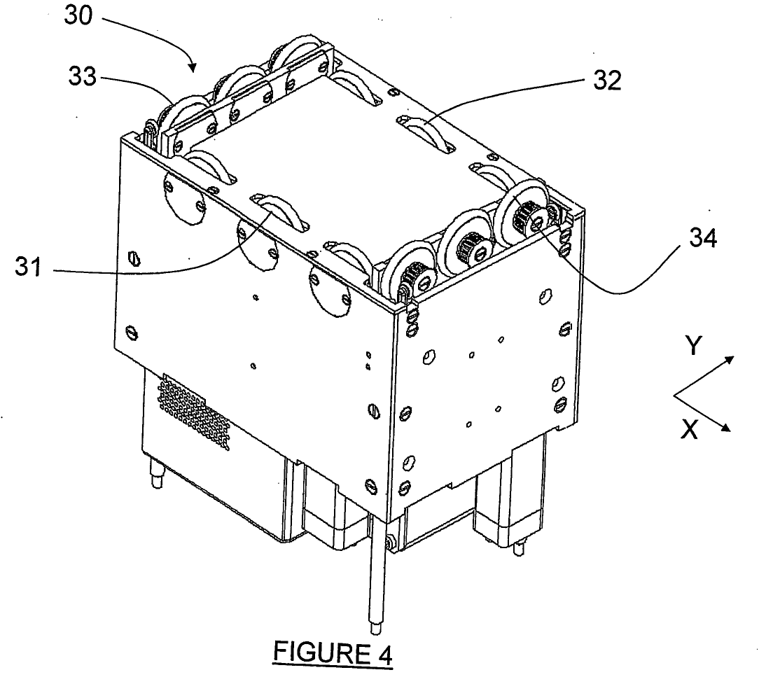

FIG. 4 shows a modular unit generally referenced 30 comprising two sets of wheels 31 and 32 oriented in the general X direction and two further sets of wheels 33 and 34 are entered in the Y direction. The modular unit illustrated may therefore be referred to as an X and Y modular unit. Means are provided to lift wheel sets 33 and 34 so that they only engage a work piece whilst the wheel sets 31 and 32 are spaced from the work piece. This configuration would allow the displacement of a work piece from propulsion in the X direction to a mode of propulsion in the Y direction. The lift and drive mechanisms may be selected by the person skilled in the art from known alternatives and may occupy the central region of the modular unit.

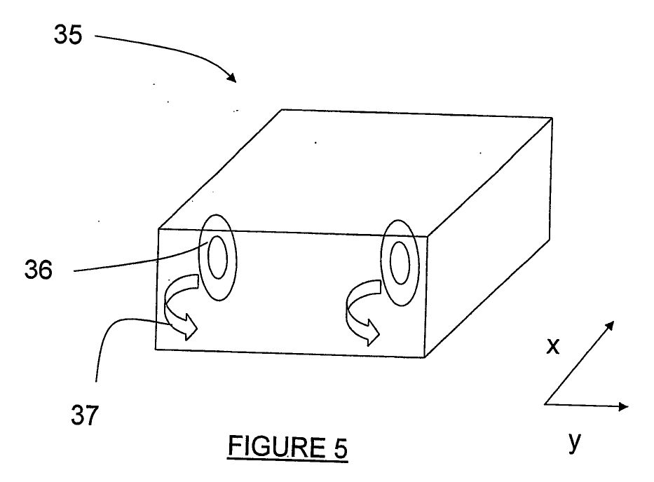

FIG. 5 shows a further modular unit generally referenced 35 which schematically illustrates an embodiment of a modular unit comprising at least one wheel which may selectively engage a work piece by lifting and lowering a wheel such as that referenced 36 and simultaneously providing means to rotate for example as indicated by arrow 37 in order to allow a single wheel or a set of wheels to displace a work piece along the top of the modular unit within the X and Y plane. The drive means and control means necessary to accomplish this function may be selected by the person skilled in the art from known alternatives.

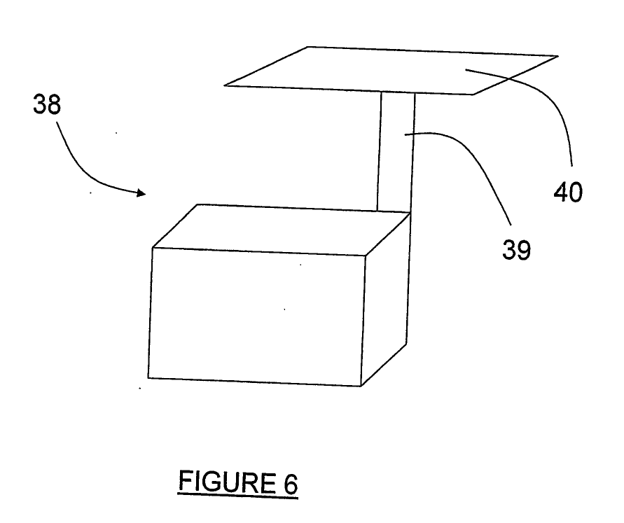

FIG. 6 shows a further modular unit generally referenced 38. An actuator 39 is shown protruding from the top of the unit and will be selected to be suitable for lifting a work piece such as that referenced 40. This embodiment may be used as a stacker for laying pallets one on top of the other. This embodiment also allows other work pieces (not illustrated in the figure) to be propelled across the top surface of the modular unit whilst one or more work pieces are lifted out of the line of displacement of the propelled work pieces.

The modular units described above may be employed in an array of modular units where each unit is of substantially equal height. The term ‘substantially equal height’ is intended to be interpreted broadly and would for example allow fluctuations of say 10 mm between neighbouring units to allow the ready passage of a work piece from one unit to the next. In this sense, an X modular unit may be 10 mm lower than a Y modular unit whilst for an XY modular unit, the X propelling region would be 10 mm lower than the Y propelling region when in propelling mode.

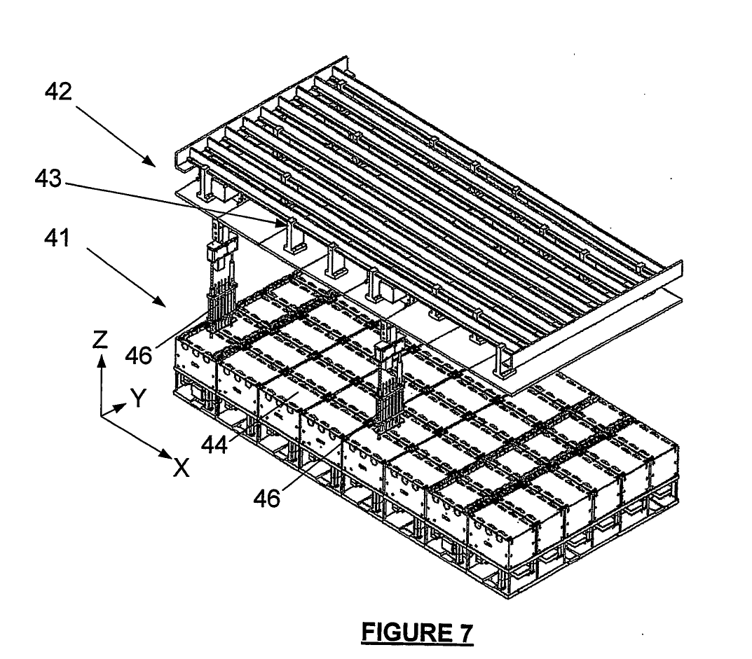

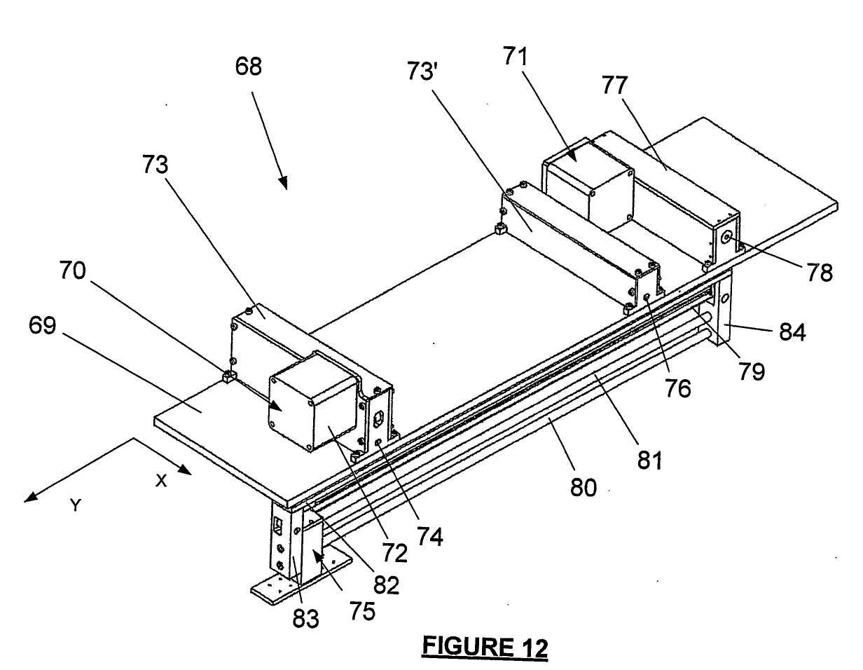

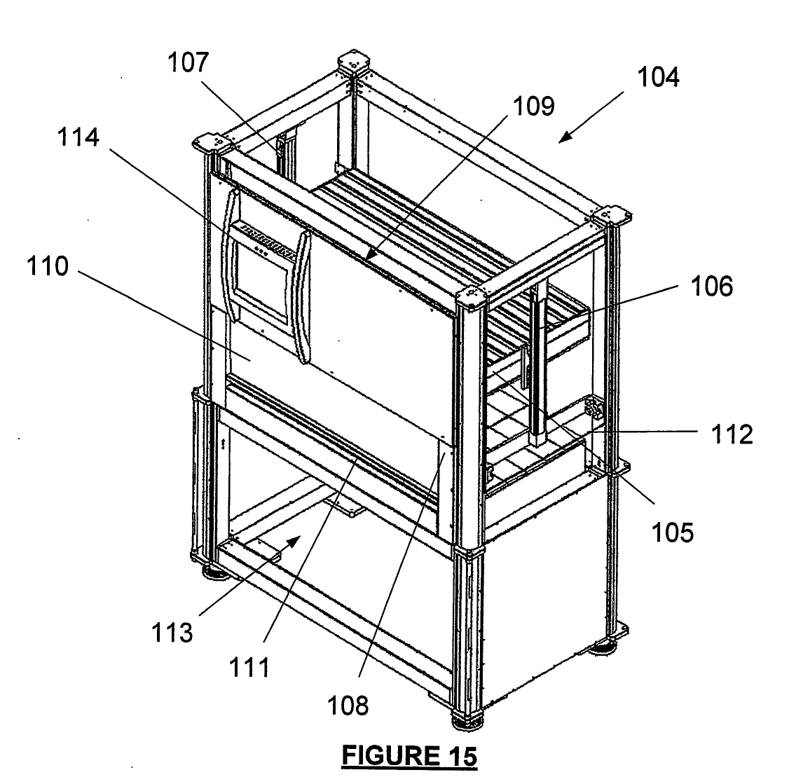

FIG. 7 shows an array of the modular units generally referenced 41 associated with an array of further modular units suspended above modular units array 41 and generally referenced 42. The lower array of modular units 41 comprises a mixture of modular units for displacing work pieces 43 in the X direction such as that referenced 44 under a number of modular units for displacing work pieces in both the X and Y directions. The array of above modular units may include a liquid injecting or aspirating head 46. Each head 46 may include a single nozzle or an array of nozzles corresponding to the array of cavities located in the work pieces which are to be displaced along the array of modular units for various treatments. The array of suspended units may be plates of the kind described and illustrated in FIG. 12. Eight plates have been included in this embodiment only two of which are as that of FIG. 12. The plates are themselves suspended from hooks and support bars assemblies such as that referenced 43. The support bars are held together at their extremities by L shaped beams which may be secured to the walls of an enclosure or to a Z displacing arrangement as will be described in more detail with reference to FIG. 15.

The invention also envisages that each individual nozzle head may be individually detachable from the array of nozzle heads so as to be itself modular. Means may be provided to allow the controlled displacement of head 46 from one location to another within the X and Y plane. Means may also be provided to displace the head in the Z direction as appropriate.

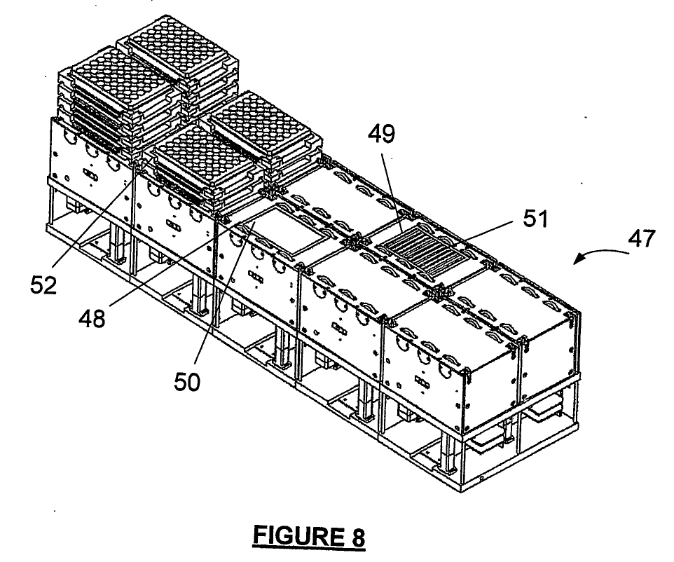

FIG. 8 shows a further array of modular units generally referenced 47 where unit 48 and unit 49 incorporate in their top face respectively, a liquid bath 50 and a lighting unit 51 which allow a treatment of a work piece from below.

Means may be provided to pick any one of the work piece from the stack 52 and place the appropriate work piece on the top surface for treatment and propulsion to further units on this co-planar array. The co-planar array of this embodiment is particularly advantageous when the work pieces contain liquid biological samples in their open cavities.

The work piece treatment devices envisaged in this invention, in the context of analysis of biological material, may be from the group comprising:
Liquid handling devices;
Liquid supplying devices;
Chemical baths;
Apparatus for changing disposable tips;
Removal devices;
Mixers;
Ultrasonic devices, particularly for cleaning;
Optical measurement devices;
Sensors of all kind;
Heat exchangers for heating, maintaining a constant temperature and cooling samples; these heat exchangers may be displaceable by using a cylinder. The heat exchangers may be selected from a range of known devices such as ‘Peltier’ coolers and/or resistance heaters if appropriate;
Devices for tilting work pieces;
Devices for locating work pieces in a 3 dimensional position;
Head changing device;
Any other biological treatment device.

The control means for a typical multi-functional array of modular units of the kind illustrated in FIG. 7 utilize processing means located at a central point which store a number of operative protocols dependent on a variety of work piece types. Dependent on whether for example the work piece is of a first kind of plate rather than a second kind of plate, the central processing means would trigger a series of operations to be carried out of a different kind by a variety of modular units. The processing means would also be adapted to establish, given the number of protocols operating simultaneously which would be the best route to employ and in which order the operations should be carried out for maximum efficiency.

If for example two protocols operate simultaneously, the control means may coordinate the operation at one process step of both protocols. For example, the control means may coordinate one step of a first kind of protocol and one step of a second kind of protocol to achieve a coordinated copying operation.

Means may be provided to assess the operation of a given protocol which may result in the interruption of a protocol mid-course and the adoption of another protocol if certain pre-determined criteria are met.

The instructions from the processing means would be broadcast to each unit to trigger their response in terms of a pre-determined displacement or rotation of the wheel sets, if appropriate. It is envisaged that means will be provided to coordinate the displacement from one unit to the next by establishing a direct communication from one unit to its direct neighbouring units. For example, if each unit uses stepper motors to drive the rotation of the wheels then the control protocol of two neighbouring units causes coordinated displacement in order to displace a work piece from one modular unit to its neighbour.

A bus arrangement is provided to allow each individual unit to hear a broadcast.

The system is arranged to cope with at least three different kinds of pauses. The first being when no more work pieces are being fed into the system, whereby the system halts only after the work pieces which are already in the system complete their predetermined sequence of operations. The second is the interruption of one or more tasks in the process, whereby the operations which have not been interrupted are pursued. The protocol may also choose alternate routes if available due to the interruption. The third is an immediate complete halt of the system.

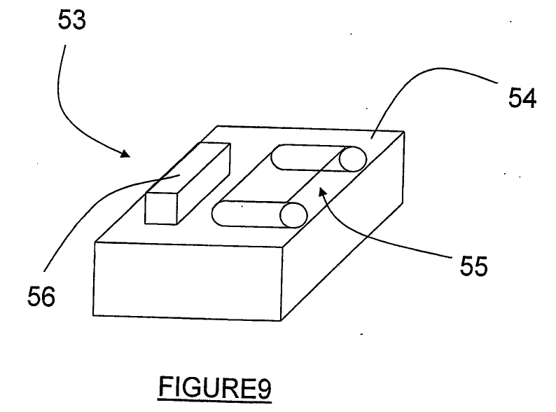

FIG. 9 shows a further possible embodiment of the invention incorporating a further modular unit generally referenced 53 with a top surface 54. The top surface 54 incorporates a conveyor schematically illustrated in the figure and referenced 55 allowing the transportation of a work piece across the top of the unit. A region of the top surface is occupied by a work piece treatment device referenced 56 which may be equipped by say optical assessment means to assess a work piece when carried by the conveyor.

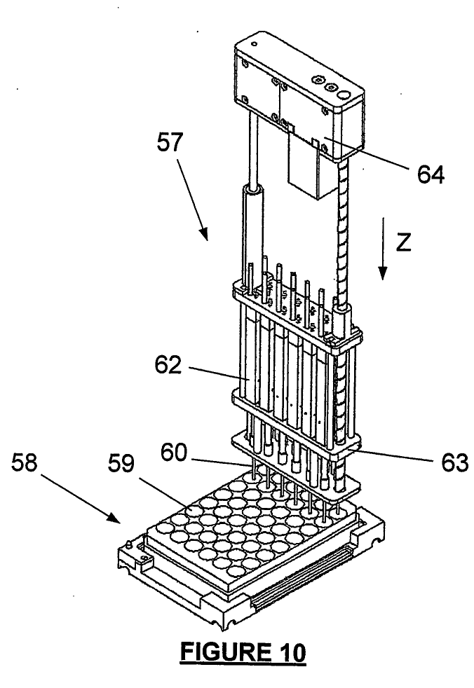

FIG. 10 shows an example of a possible suspended head of the kind introduced in FIG. 7 above. Head 57 is adapted to be suspended above a work piece 58 having an array of cavities such as that referenced 59. Head 57 comprises a number of tips such as that referenced 60. Each tip 60 is displaceable in the Z direction. Each tip may be adapted to either transfer or pick liquid to or from a cavity. Tip 60 may be displaced in the Z direction through pneumatic means or any other appropriate means selected by the person skilled in the art such as a stepper motor. Each tip is spring loaded within a housing such as that referenced 62 so that once a tip has carried out its operation on its corresponding cavity, it may automatically return to its idle position. An example of an idle position is that shown by tip 60.

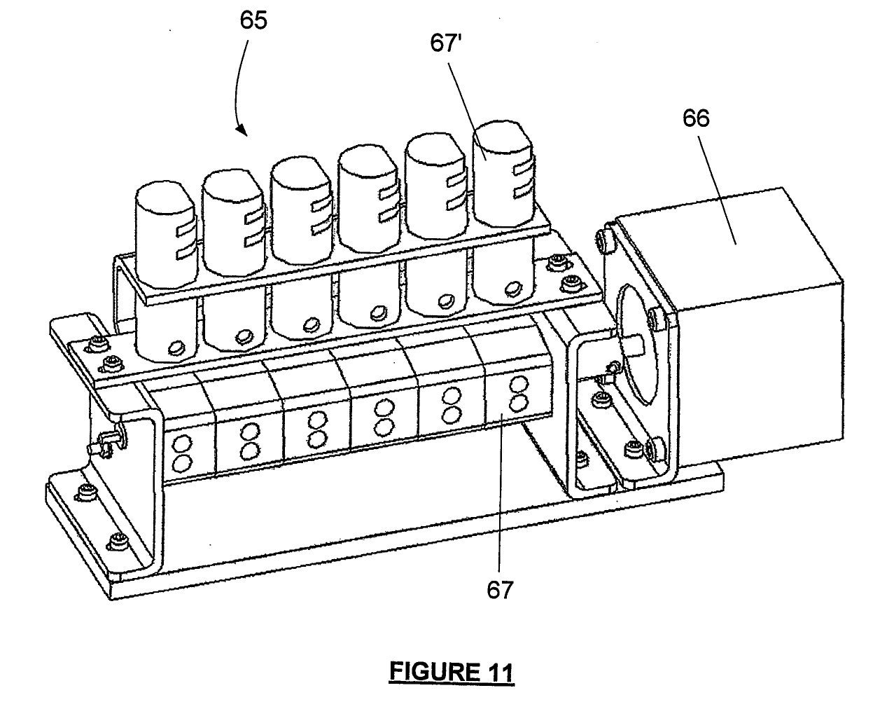

Head 57 has an array of 12 tips which are held together at the lower extremity of the housing 62 by a plate 63 which has a number of cut outs in order to accommodate each tip. The control means of each tip is located in an upper enclosure 64. The head control means may be set to operate in a synchronous mode or to operate each tip on an individual basis. A single pump unit may be used to operate an array of tips. An example of such a pump unit is shown in FIG. 11 and referenced 65. A stepper motor 66 in this embodiment drives a number of sub units such as that referenced 67, each of which operate in conjunction with a particular tip. Flexible conduits (not illustrated in the figure) may be provided between each sub unit and the tips. The pump may be a peristaltic pump controlled to operate in a variety of modes such as picking, mixing, aspirating and dispensing. The system envisages the use of valves or the like to permit each tip to operate individually.

Each pump unit 67 is driven for aspirating or dispensing dependent upon the direction of the rotation of the stepper motor.

In a dispensing mode, the pump may draw liquid into the pump and depend upon the position of the bypass valve 67′ operating in conjunction with the pump the liquid will either be circulated in a bypass loop or allowed to flow out towards the tip. A control system will be provided to operate each valve individually to allow any of the six tips of this system to function if selected by the control means.

Whilst this last embodiment shows the use of an array of 12 tips, plate 63 may be replaced by larger plates of similar function in order to allow a head with a greater number of tips to be achieved. This system is therefore scaleable and modular in a similar manner to the modular transportation units of the system.

FIG. 12 shows a head support frame generally referenced 68 which has a plate 69 acting as a common support plate for X stepper motor assembly 70 and Y stepper motor assembly 71. X stepper motor assembly incorporates a stepper motor housing 72 and a belt and a first X bearing rod housing 73. The end of the X bearing rod is visible in the figure and has been referenced 74. The entire head assembly 75 may be displaced in the X direction as it holds onto a first X bearing rod 74 and a second X bearing rod 76 located in housing 73′. Each housing is secured on plate 69 by the use of screws or other similar attachment means. Each housing is also attached in such a manner to form a liquid proof seal and particularly to form an ethanol proof seal.

Stepper motor 71 drives a thrust tube whose end is referenced 78 in the figure and which is located in a housing 77 in order to allow the stepper motor to transmit motion to the belt 79 to cause Y displacement irrespective of the X position reached by the arrangement. In the Y direction, head 75 may slide along Y bearing rods 80 and 81. A linkage beam 82 links Y bearing blocks 83 and 84 to X bearing rods 74 and 76. The arrangement shown achieves therefore displacements in the X and Y plane.

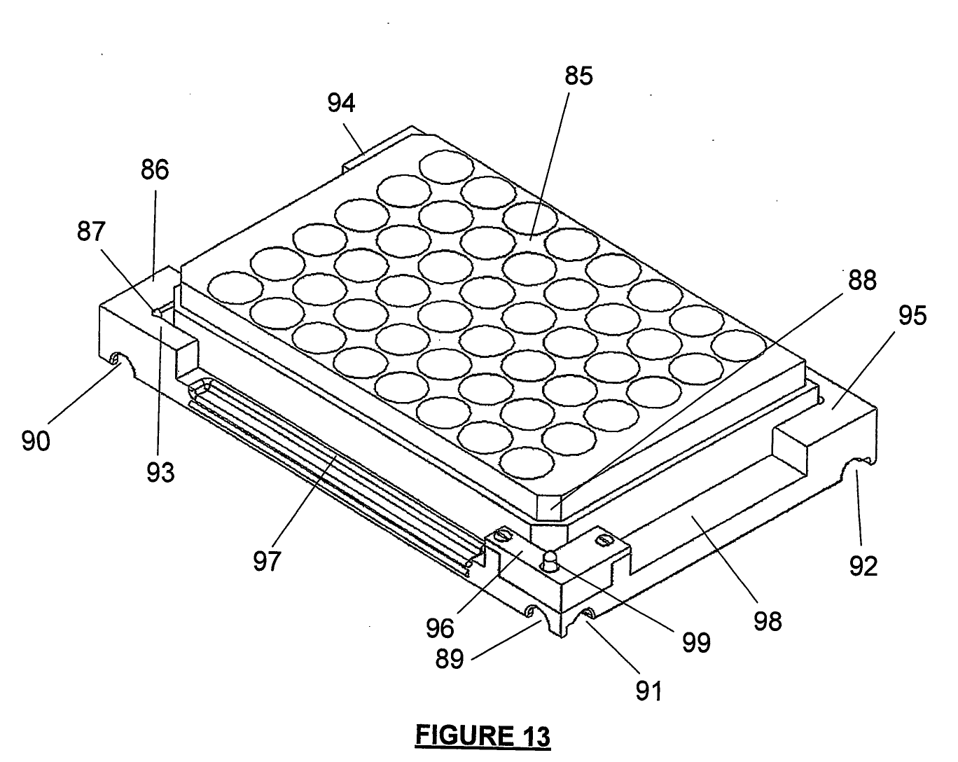

FIG. 13 shows a detailed view of a work piece 85 secured in a pallet 86. Pallet 86 has a recess of essentially rectangular shape in order to accommodate a work piece of similar shape and to prevent the work piece from accidentally exiting the pallet. The density of the pallet 86 is higher than the density of the work piece 85 arid is selected to have a sufficient mass for advantageous engagement with the wheels of the transportation means.

The corners of the pallet such as that referenced 87 are preferably rounded whilst one or more of the comrnrs of the work piece such as that referenced 88 is truncated rather than terminated in a point. Pallet 86 incorporates longitudinal recesses extending across the width such as 89 and 90 and across the length of the pallet such as the recesses terminating in 91 and 92. These recesses form guide rails in which the wheels run to drive the displacement of the pallet and work piece assembly. The pallet also has raised corner sections 93, 94, 95 and 96. The pallet also incorporates portions of lesser height such as 97 and 98. Portion 98 may allow advantageous access to a gripper arm (not illustrated in the figure) which would be able to grab the work piece to separate the work piece from its pallet. A button protrudes from corner section 96 which when pressed inwards causes a snap-fit attachment to release in order to allow the work piece to be separated from the pallet. The snap-fit allows, when the work piece is secured to the pallet, for the work piece to be secured to the pallet in a manner which would prevent the work piece to be removed through the vibration to which the work piece and pallet is submitted in use.

The system may use a wide variety of pallets and work piece assemblies; a further example of a work piece and pallet assembly may employ a work piece which has a single containing portion of rectangular shape instead of an array of cavities.

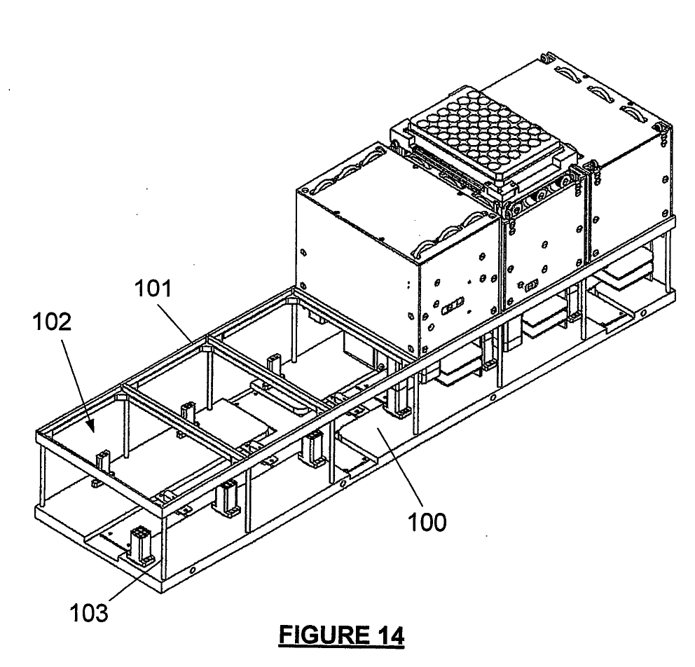

The portion of the system shown in FIG. 14 uses a modular platform 100 to which is attached to a frame 101 with six recesses such as that referenced 102 into which a modular unit may be slotted. A number of platforms such as that referenced 100 may be used side by side to form a platform of any desired size for any particular application. Frame 101 is spaced from platform 100 by a number of legs such as that referenced 103. This configuration does away with the requirement of individual units having their own legs.

FIG. 15 shows an outer enclosure 104 for use with an array of modular units and overhead services 105 such as those described with reference to FIGS. 7 and 12 which are adapted to lift along Z beams 106 and 107 to give access for service. The displacement of the overhead services may be driven by stepper motors or other forms of displacement means appropriate for this application. An outer door 108 is provided with a hinging mechanism located at 109 in order to allow it to lift in a similar manner to a car boot. A sliding door 110 which is part of the outer door 108 is also provided. An operator simply manually draws on handle 111 in an upward direction to open this door.

As part of outer door 108, a touch screen 114 is provided to allow an operator to control the operation of the modular system located within the enclosure. On the short sides of the enclosure, an automated opening may be provided to allow pallets or other work pieces to be automatically entered into the enclosure by for example a robot arm. This opening may be placed at the height shown by horizontal line 112. Beneath the lower modular units, a space 113 is provided to accommodate supply services of any kind.

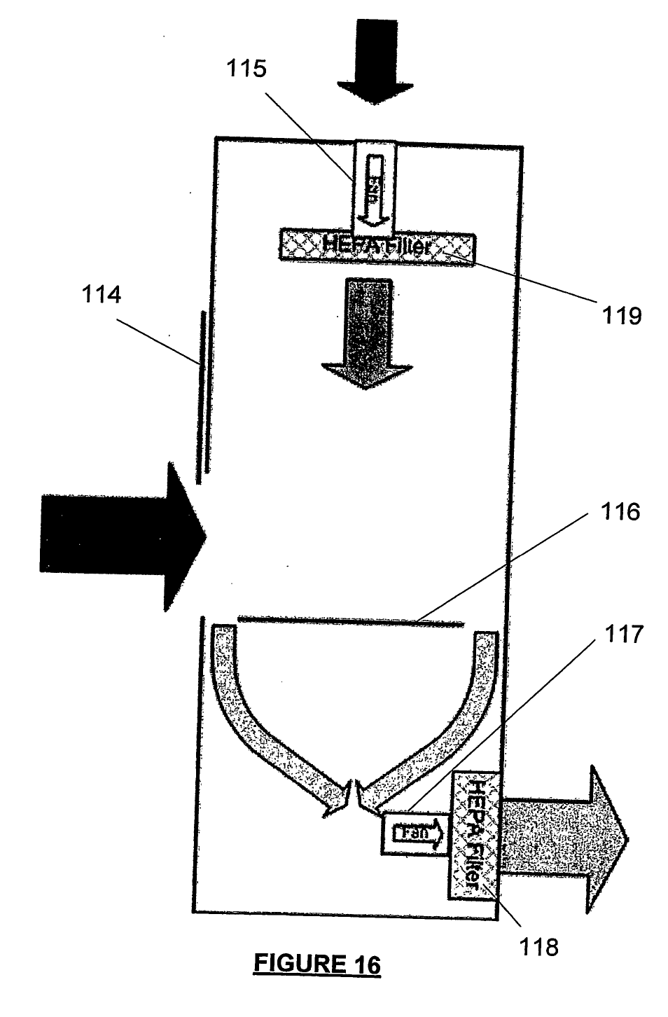

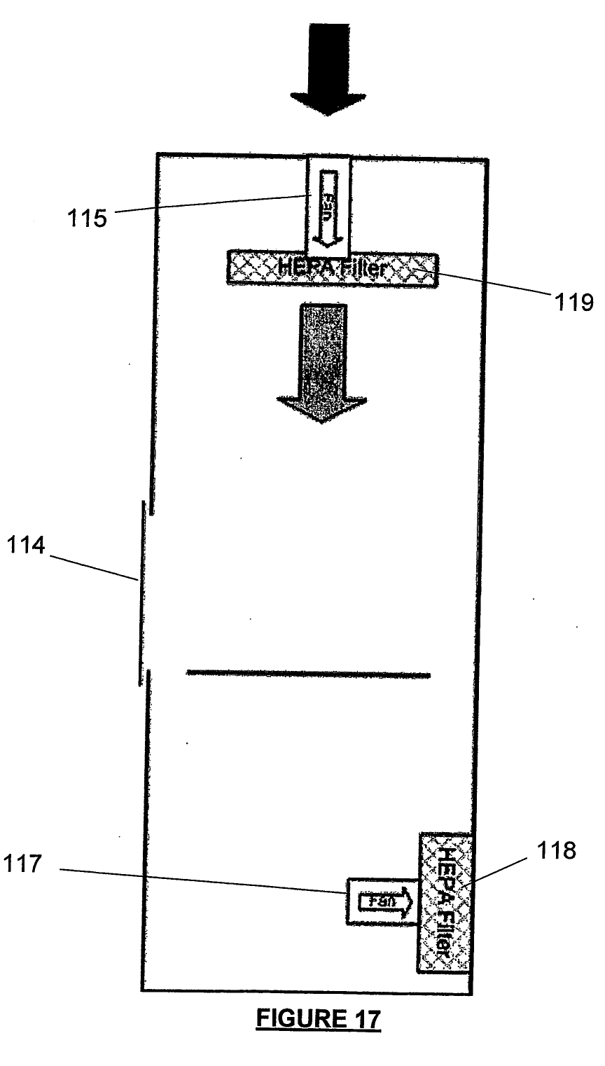

FIGS. 16 and 17 respectively show the air flow within the system in both a cleaning mode (FIG. 16) and a running mode (FIG. 17). The view is a schematic cross sectional view of the enclosure in a vertical direction In cleaning mode, a door 114 is open allowing circulation into the system, similarly a fan 115 draws air into the system which is submitted to a high efficiency particulate filter (HEPA) 119, the filtered air joins the air which enters through the door and is forced to circulate around a separation 116. The air having passed the separator 106 is then drawn through a fan 117 and a filter 118 in order to exit the system. When this system is used in the enclosure of this invention, the upper filter may be placed above the frame of the enclosure shown in FIG. 15, whilst the separation is the lower array of modular units and the lower filter may be located beneath the lower array of modular units.

In running mode, door 114 is shut whilst fan 115 and filter 119 operate; and fan 117 and filter 118 are idle.

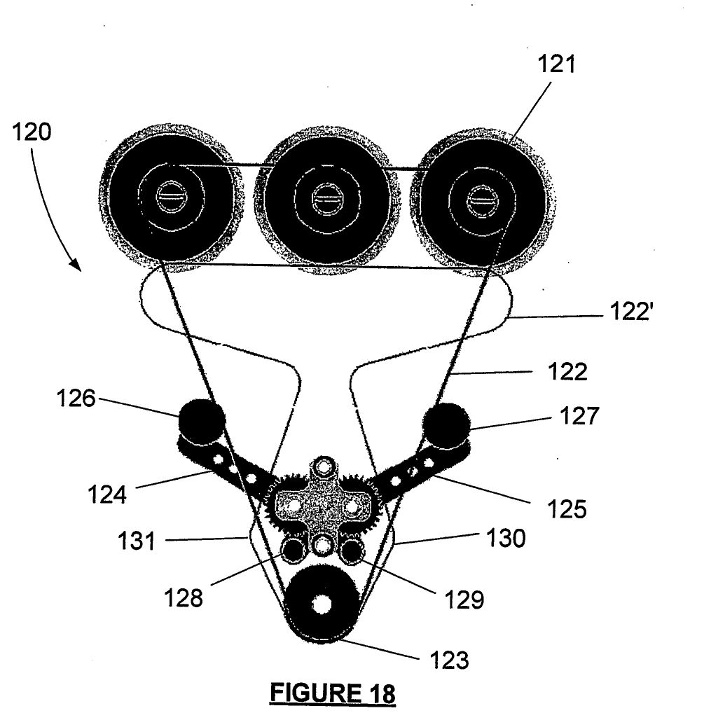

FIG. 18 shows a belt tensioning mechanism generally referenced 120. The wheels (such as that referenced 121) are shown in a raised configuration where a work piece would be lifted in order to be displaced around a corner. In this configuration belt 122 is held in tension between wheels 121 and a pulley or drive 123. Aims 124 and 125 respectively have at their outer most extremity wheels 126 and 127 which are biased to pivot inwardly in order to tension belt 122.

As wheels 121 are lowered arms 124 and 125 draw belt 122 as shown in the representation 122′. Simultaneously, members 128 and 129 displace respectively with arms 126 and 127 and engage belt 122′ at locations 130 and 131 in order to apply tension on the belt. This arrangement allows the loss of tension to be prevented in such a system which would otherwise result in inaccurate displacement of the wheels.

The scope of the invention is defined in the claims that follow.

1-18. (canceled)

19. A modular unit for transporting work pieces and suitable for use in an array of such units, comprising a top; a driven transportation arrangement which propels the work pieces onto and/or off said top and against which the work pieces rest when located on the top of the unit, the transportation arrangement being part of said top; a controller for controlling the driving of said transportation arrangement and a top plate segregating said controller from any work piece being transported; wherein said driven transportation arrangement is located substantially in at least two spaced apart locations of said top and the space between said locations is not occupied by the driven transportation arrangement; whereby said space is suitable for receiving a work piece treatment device.

20. A modular unit according to claim 19, wherein the transportation arrangement is located substantially about the periphery of the top and the region of the top of the unit located within the periphery of the top is suitable for receiving a work piece treatment device.

21. A modular unit according to claim 19, wherein the transportation arrangement comprises a wheel, a drive causing the wheel to rotate, and an arrangement to selectively engage the wheel with a work piece, when a work piece is located on the top of the unit.

22. A modular unit according to claim 19, wherein the unit comprises at least one wheel for driving the work piece in one direction and at least one second wheel which selectively engages the work piece and is oriented, in use, in a second direction.

23. A modular unit according to claim 22, wherein the at least one second wheel of the unit engages and lifts the work piece; whereby the work piece only engages the second wheel.

24. A modular unit according to claim 22, wherein the at least one wheel of the unit and the at least one second wheel of the unit are orthogonal one relative to the other.

25. A modular unit according to claim 19, wherein the unit comprises two compartments: one for receiving a work piece treatment device located in an upper compartment of the unit and a second containing the control electronics; and a separating member is provided to seal the second compartment from the first compartment.

26. A modular unit according to claim 19, further comprising a work piece lifting component, the component being sufficiently spaced from the unit top to allow the transportation arrangement to continue to transport work pieces whilst lifting one work piece.

27. An array of modular units, wherein the units are each in accordance with claim 19 and of substantially equal height and a controller is provided to control the displacement in the X and Y plane from one unit to another.

28. An array of modular units according to claim 27, wherein each unit has a controller which allows the direct communication from one unit to its direct neighbouring units, whereby the transportation from one unit to the next may be coordinated.

29. An array of modular units according to claim 27, wherein a further array of modular units is suspended above the units comprising work piece treatment devices.

30. An array of modular units according to claim 27, wherein the controller stores a number of operative protocols dependent on work piece types, selects the appropriate operative protocol dependent on the work piece to instruct the operation of a series of units, and the controller controls the unit; whereby several protocols may run in parallel in the array of modular units.

31. An array of modular units according to claim 27, wherein at least one plate is provided with recessed portions into which modular units are selectively inserted and removed.

32. A modular unit according to claim 19, comprising at least one component which protrudes from the top of the unit and which is so sized and shaped to engage a conical recessed portion of a work piece when located on the top, whereby the position of the work piece on the top of the unit may be accurate.

33. A modular unit according to claim 21, wherein the unit operates in conjunction with a pallet which has one or more recessed tracks corresponding to one or more wheels.

34. A modular unit according to claim 19, comprising a sensor for sensing the position of a work piece when located over said sensor.

35. A tensioning arrangement, for one of a belt drive and a chain drive of the kind in which a temporarily induced slackness in one of the belt and chain must be compensated automatically and followed, if subsequently necessary, by a correspondingly opposite sense movement of the tensioner to release the tension previously imposed; wherein the tensioner comprises first and second arms arranged in a mirror-image formation to bear simultaneously in use against respectively opposite runs of one of the belt and chain.
